(19) United States
(12) Patent Application Publication
(10) Pub. No.: US 2013/0314949 A1
(43) Pub. Date: Nov. 28, 2013

(54) POWER CONVERTER AND METHOD OF CONTROLLING THE SAME

(71) Applicants: Tse-Hua CHI, Taoyuan County (TW); Chung-Hsi CHIANG, Taoyuan County (TW)

(72) Inventors: Tse-Hua CHI, Taoyuan County (TW); Chung-Hsi CHIANG, Taoyuan County (TW)

(73) Assignee: DELTA ELECTRONICS, INC., Taoyuan County (TW)

(21) Appl. No.: 13/619,827

(22) Filed: Sep. 14, 2012

(30) Foreign Application Priority Data
May 25, 2012 (TW) 101118642

(51) Int. Cl. H02M 3/335

(52) U.S. Cl. 363/17

(57) ABSTRACT

A power converter includes a full-bridge switching circuit, a resonant circuit, a transformer, an over-voltage protection unit, a PWM control unit, a trigging control unit, and a driving unit. The over-voltage protection unit detects an output voltage of the power converter to produce an output voltage signal. The PWM control unit produces PWM signals. The trigging control unit receives the output voltage signal and the PWM signals to produce a trigging control signal. When an over-voltage output is detected by the over-voltage protection unit, the trigging control unit outputs the low-level trigging control signal to disable the driving unit at the end of duty cycle of the PWM signals.

This application is based on and claims the benefit of Taiwan Application No. 101118642 filed May 25, 2012 the entire disclosure of which is incorporated by reference herein.

### BACKGROUND

1. Technical Field

The present disclosure relates generally to a power converter and a method of controlling the same, and more particularly to a power converter and a method of controlling the same for a mobile vehicle.

2. Description of Related Art

For today's technologies of driving mobile vehicles, that will be developed toward the trend of pollution-free and high-efficiency purposes. The battery is usually used to store the desired energy for the electric vehicles. In particular, the various generated energies, such as coal-fire energy, hydraulic energy, wind energy, thermal energy, solar energy, and nuclear energy, have to be converted into the electrical energy so that the electrical energy can be stored in the battery. However, the major issues of security, efficiency, and convenience have to be concerned during the energy conversion process.

Reference is made to FIG. 1 which is a schematic block diagram of a prior art charging apparatus of a mobile vehicle. The charging apparatus 10A receives an external AC voltage Vs and the external AC voltage Vs is converted into a DC output voltage Vo by the charging apparatus 10A to charge a rechargeable battery 20A.

The charging apparatus 10A includes an EMI filter 102A, a power factor corrector 104A, an isolated power converter 106A, and a non-isolated power converter 108A. The EMI filter 102A is provided to receive the external AC voltage Vs and eliminate the noise in the AC source Vs, thus preventing the conductive electromagnetic interference. The power factor corrector 104A is electrically connected to the EMI filter 102A to improve the power factor of the converted DC source. The isolated power converter 106A is electrically connected to the power factor corrector 104A to convert and output the energy produced from the power factor corrector 104A. The non-isolated power converter 108A is electrically connected to the isolated power converter 106A to provide different voltage levels, thus providing the required charging voltage for the rechargeable battery 20A.

In practical applications, a LLC full-bridge series resonant converter is adopted as the isolated power converter 106A. The resonant converter achieves zero voltage/current switching by the resonant circuit using the frequency modulation, and in accordance with the load characteristics. In which, the current phase lags the voltage phase to achieve the zero voltage switching, whereas the current phase leads the voltage phase to achieve the zero current switching. Traditional resonant converters are mainly divided into series resonant converters, parallel resonant converters, and series parallel resonant converters. These three circuit architectures can achieve zero voltage or zero current switching, but the series resonant converters cannot adjust output voltage in light load conditions, thus having problems in voltage regulation. LLC resonant converter is evolved by combining the half-bridge or full bridge converter with the series resonant circuit. Operation under the normal working voltage, the duty cycle of the power switches is operating at close to 50% complementary signal, and through the modulation of the switching frequency to achieve a stable output voltage.

Reference is made to FIG. 2 which is a schematic block diagram of a prior art LLC full-bridge series resonant converter. The control architecture of the isolated power converter 106A is an open-loop design. For this reason, the output voltage regulation of the isolated power converter 106A is related to load conditions, duty cycle, conduction voltage drop of power components, and so on. Hence, the output voltage of the isolated power converter 106A would continuously increase when the isolated power converter 106A is operated under the light load condition, thus resulting in poor voltage regulations. Accordingly, an over-voltage protection scheme is usually used in order to achieve voltage regulations under light load operations.

Reference is made to FIG. 2 which is a schematic block diagram of a prior art LLC full-bridge series resonant converter. The power converter 106A of the charging apparatus is electrically connected to a DC input voltage (not labeled) to convert and output the energy produced from the DC input voltage. The power converter 106A includes a full-bridge switching circuit 1061A, a resonant circuit 1062A, a transformer 1063A, an over-voltage protection unit 1064A, a PWM control unit 1065A, and a driving unit 1067A.

The full-bridge switching circuit 1061A, which has two bridge legs (not labeled) composed of four power switches, is provided to convert the DC input voltage into a square wave voltage (not shown). The resonant circuit 1062A is electrically connected to the full-bridge switching circuit 1061A to receive the square wave voltage and covert the square wave voltage into a resonant voltage (not shown). The resonant circuit 1062A has a resonant capacitance Cr and two resonant inductances (one is a leakage inductance Lr and the other is a magnetizing inductance (not shown)) to form a LLC resonant circuit. The transformer 1063A has an input side and in output side. The input side is electrically connected to the resonant circuit 1062A to receive the resonant voltage. In particular, the input side has at least one primary-side winding (not labeled) and the output side has at least one secondary-side winding (not labeled). As previously stated, the resonant inductances in the resonant circuit 1062A are the leakage inductance Lr of the transformer 1063A and the magnetizing inductance.

The over-voltage protection unit 1064A is electrically connected to the output side of the transformer 1063A to detect an output voltage of the power converter 106A and produce an output voltage signal Sovp, thus providing an over-voltage protection for the power converter 106A. The PWM control unit 1065A produces PWM signals. Because the full-bridge switching circuit 1061A is composed of two bridge legs and each of the bridge legs has two power switches, the produced PWM signals by the PWM control unit 1065A include a first PWM signal Spwm1 and a second PWM signal Spwm2. In particular, the first PWM signal Spwm1 and the second PWM signal Spwm2 are complementary-level signals, that is, the second PWM signal Spwm2 is a low-level signal when the first PWM signal Spwm1 is a high-level signal, and vice versa.

The over-voltage protection unit 1064A produces the output voltage signal Sovp to disable the driving unit 1067A to stop driving the full-bridge switching circuit 1061A when an over-voltage output of the power converter 106A is detected by the over-voltage protection unit 1064A. On the other hand, when a working-voltage output is detected (namely, the over-voltage output is eliminated) by the over-voltage protection unit 1064A, the over-voltage protection unit 1064A produces the output voltage signal Sovp to enable the driving unit 1067A driving the full-bridge switching circuit 1061A. In addition, the power converter 106A further has an optical coupling unit 1068A. The output voltage signal Sovp is sent from the over-voltage protection unit 1064A to the driving unit 1067A via the optical coupling unit 1068A.

However, the output voltage signal Sovp is immediately provided to disable or enable the driving unit 1067A when the over-voltage output or the working-voltage output of the power converter 106A is detected by the over-voltage protection unit 1064A. Reference is made to FIG. 3 is a timing diagram of controlling a prior art PWM control unit and a driving unit. The graph of FIG. 3 shows, starting from the top, the first PWM signal Spwm1, the second PWM signal Spwm2, the dead time Td, the output voltage signal Sovp, the gate-driving signals Sga, Sgd, and the gate-driving signals Sgb, Sgc.

As previously stated, the first PWM signal Spwm1 and the second PWM signal Spwm2 are complementary-level signals. The first PWM signal Spwm1 is turned-on during a time interval t10˜t11, in the meanwhile, the second PWM signal Spwm2 is turned-off. In addition, the second PWM signal Spwm2 is turned-on during a time interval t12˜t13, in the meanwhile, the first PWM signal Spwm1 is turned-off. Note that, the first PWM signal Spwm1 and the second PWM signal Spwm2 are periodic complementary-level signals.

Furthermore, it is assumed that the power converter 106A occurs the over-voltage output at a time tov. Hence, the over-voltage protection unit 1064A produces the low-level output voltage signal Sovp when the over-voltage output of the power converter 106A is detected by the over-voltage protection unit 1064A. That is, the second PWM signal Spwm2 is a high-level turned-on status (relatively, the first PWM signal Spwm1 is a low-level turned-off status) when the over-voltage output occurs between the time t12 and a time t23. At this time, the high-level output voltage signal Sovp is immediately converted into the low-level output voltage signal Sovp to disable the driving unit 1067A to stop driving the full-bridge switching circuit 1061A. Similarly, the over-voltage protection unit 1064A immediately outputs the low-level output voltage signal Sovp to disable the driving unit 1067A when the over-voltage output is detected during the time interval t12˜t13.

On the other hand, it is assumed that the over-voltage output of the power converter 106A is eliminated at a time tnv, that is, when the working-voltage output is detected by the over-voltage protection unit 1064A, the over-voltage protection unit 1064A outputs the high-level output voltage signal Sovp. When the working-voltage output is detected during a time interval t14˜t15, the first PWM signal Spwm1 is a high-level turned-on status (relatively, the second PWM signal Spwm2 is a low-level turned-off status). At this time, the low-level output voltage signal Sovp is immediately converted into the high-level output voltage signal Sovp to enable the driving unit 1067A driving the full-bridge switching circuit 1061A. Similarly, the over-voltage protection unit 1064A immediately outputs the high-level output voltage signal Sovp to enable the driving unit 1067A when the working-voltage output is detected during the time interval t14˜t15.

Accordingly, the duty cycle of disabling or enabling the driving unit 1067A would not be full period, namely, a 5%, 10%, or 15% duty cycle would be provided to disable or enable the driving unit 1067A. For this reason, the energy stored in energy-storage components would not be completely released in a duty cycle so that the non-released energy will be instantaneously released in the next period resulting in an undesirable short through operation.

Accordingly, it is desirable to provide a power converter and a method of controlling the same so that an output voltage signal produced from an over-voltage protection unit is used to control a trigging control unit to disable a driving unit at an end of duty cycle of the PWM signals when an over-voltage output is detect by the over-voltage protection unit.

### SUMMARY

An object of the invention is to provide a power converter to solve the above-mentioned problems. The power converter includes a full-bridge switching circuit, a resonant circuit, a transformer, an over-voltage protection unit, a PWM control unit, a trigging control unit, and a driving unit.

The full-bridge switching circuit converts a DC input voltage into a square wave voltage. The resonant circuit is electrically connected to the full-bridge switching circuit to receive the square wave voltage and convert the square wave voltage into a resonant voltage. The transformer has an input side and an output side; the input side is electrically connected to the resonant circuit to receive the resonant voltage. The over-voltage protection unit is electrically connected to the output side to detect an output voltage outputted from the output side and produce an output voltage signal. The PWM control unit produces PWM signals. The trigging control unit receives the output voltage signal and the PWM signals and produces a trigging control signal. The driving unit receives the trigging control signal and the PWM signals to turn on or turn off the full-bridge switching circuit. The trigging control unit outputs a low-level trigging control signal to disable the driving unit at an end of duty cycle of the corresponding PWM signal when an over-voltage output is detected by the over-voltage protection unit.

Another object of the invention is to provide a method of controlling a power converter to solve the above-mentioned problems. The method includes the following steps: (a) a full-bridge switching circuit, a resonant circuit, and a transformer are provided; (b) an over-voltage protection unit is provided to detect an output voltage of the power converter and produce an output voltage signal; (c) a PWM control unit is provided to produce PWM signals; (d) a trigging control unit is provided to receive the output voltage signal and the PWM signals and produce a trigging control signal; (e) a driving unit is provided to receive the trigging control signal and the PWM signals to turn on or turn off the full-bridge switching circuit; (f) a low-level trigging control signal is outputted by the trigging control unit to disable the driving unit at an end of duty cycle of the corresponding PWM signal when an over-voltage output is detected by the over-voltage protection unit.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWINGS

FIG. 1 is a schematic block diagram of a prior art charging apparatus of a mobile vehicle;

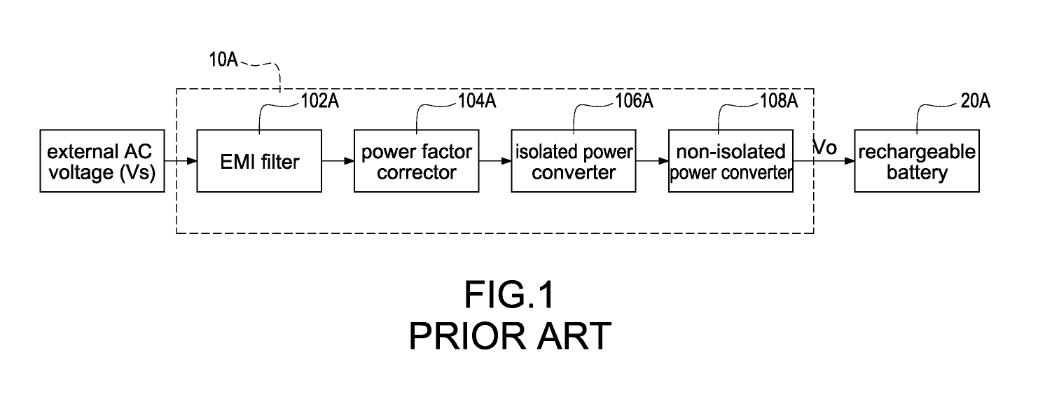

FIG. 2 is a schematic block diagram of a prior art LLC full-bridge series resonant converter;

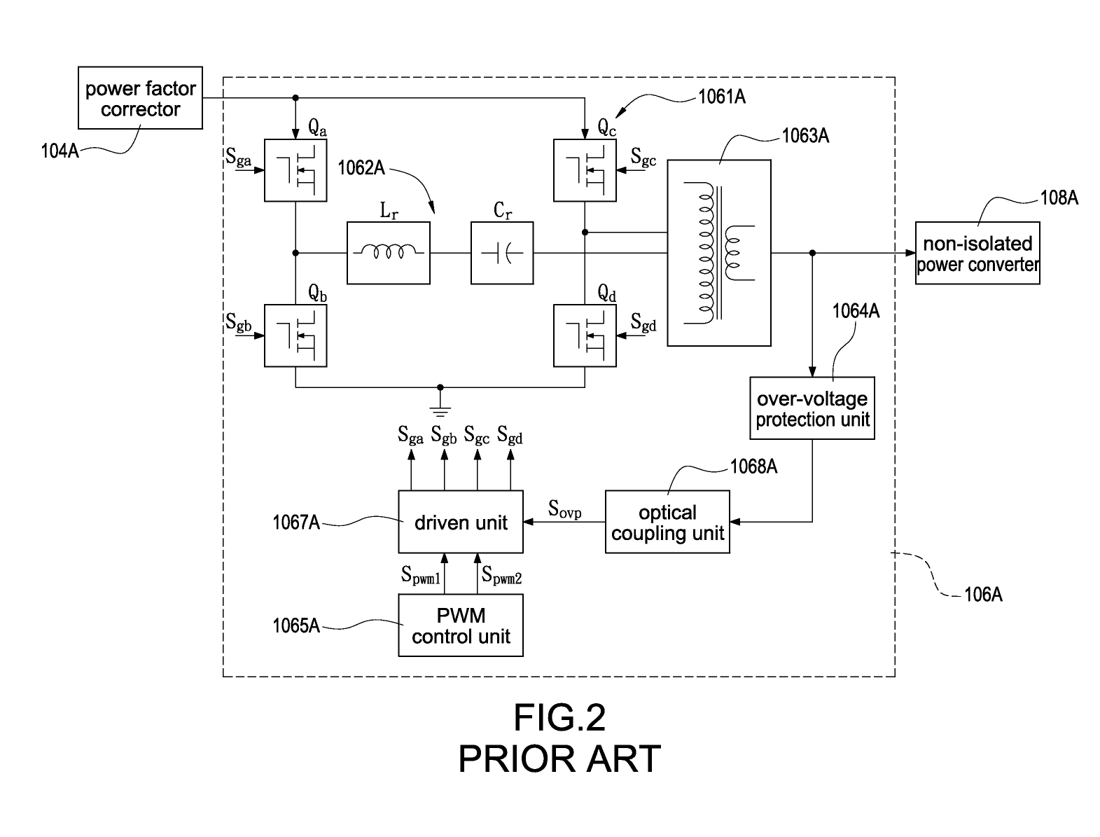

FIG. 3 is a timing diagram of controlling a prior art PWM control unit and a driving unit;

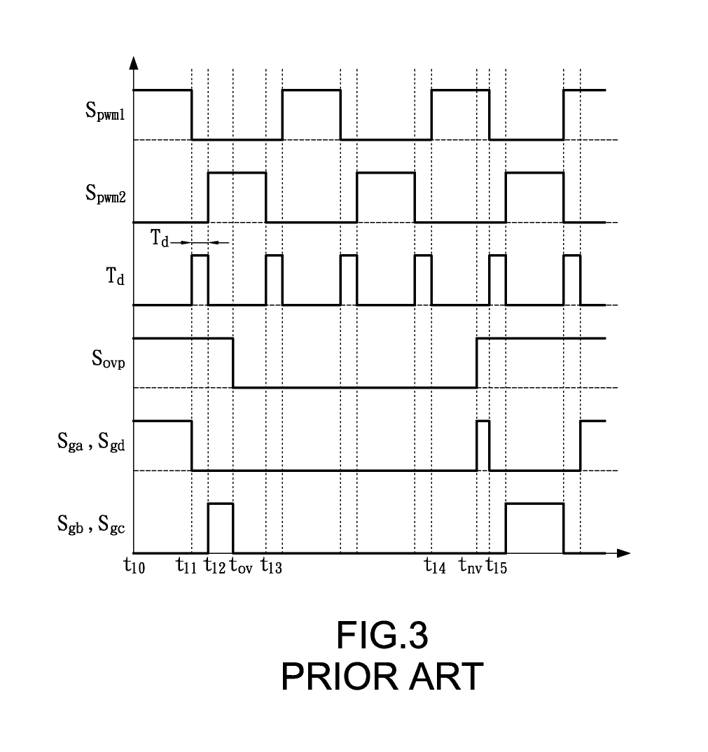

FIG. 4 is a schematic circuit block diagram of a power converter of a charging apparatus according to the present invention;

FIG. 5 is a circuit diagram of a trigging control unit according to the present invention;

FIG. 6 is a timing diagram of controlling a PWM control unit, a trigging control unit, and a driving unit according to the present invention; and

FIG. 7 is a flowchart of a method of controlling a power converter according to the present invention.

### DETAILED DESCRIPTION

Reference will now be made to the drawing figures to describe the present invention in detail.

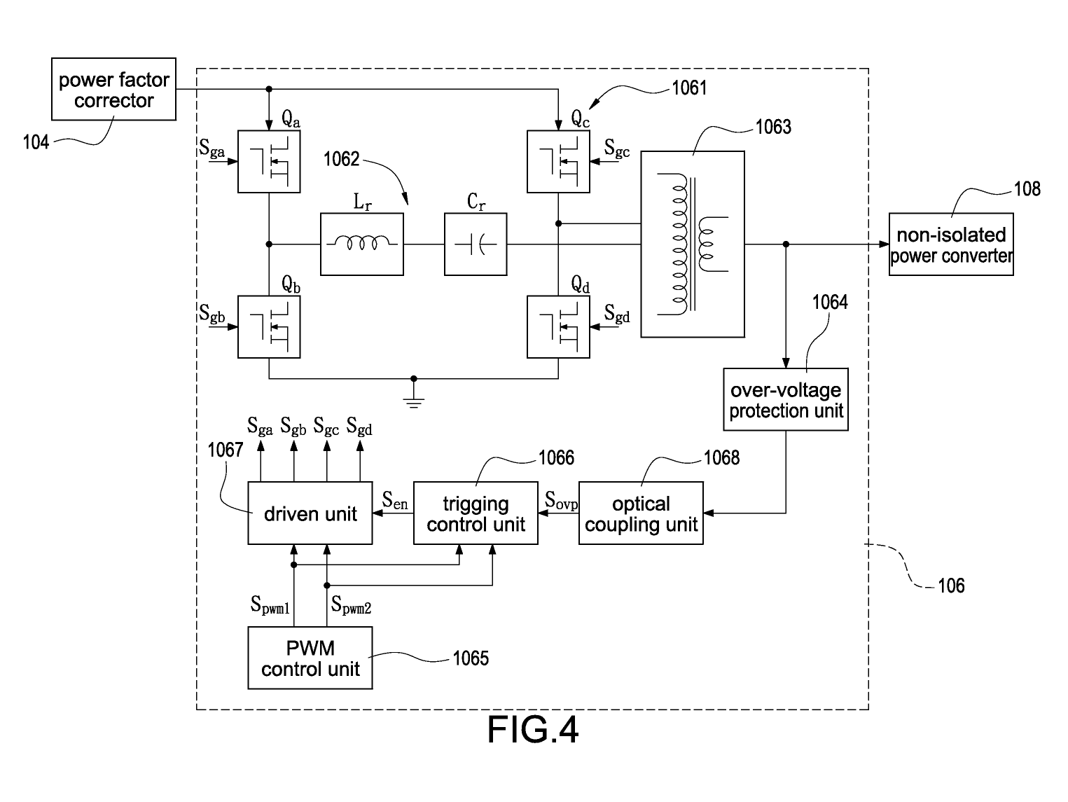

Reference is made to FIG. 4 which is a schematic circuit block diagram of a power converter of a charging apparatus according to the present invention. The charging apparatus includes an EMI filter (not shown), a power factor corrector 104, an isolated power converter 106 (also referred to as an isolated DC-to-DC converter), and a non-isolated DC-to-DC converter 108 (also referred to as a non-isolated DC-to-DC converter). Because the above-mentioned circuit apparatuses except the isolated power converter 106 are identical to the prior art technology, the detail description is omitted here for conciseness. The detailed description of the power converter 106 will be made hereinafter.

The isolated power converter 106 of the charging apparatus is electrically connected to a DC input voltage (not labeled) to convert and output the energy produced from the DC input voltage. The power converter 106 includes a full-bridge switching circuit 1061, a resonant circuit 1062, a transformer 1063, an over-voltage protection unit 1064, a pulse-width modulation control unit 1065 (referred to as a “PWM control unit” hereinafter), a trigging control unit 1066, and a driving unit 1067.

The full-bridge switching circuit 1061 has two bridge legs (not labeled) composed of four power switches for converting the DC input voltage into a square wave voltage (not shown). That is, the full-bridge switching circuit 1061 has a first power switch Qa, a second power switch Qb, a third power switch Qc, and a fourth power switch Qd. Each bridge leg is composed of two power switches. In this embodiment, the first power switch Qa and the second power switch Qb form a first bridge leg; the third power switch Qc and the fourth power switch Qd form a second bridge leg. Especially, a dead time is provided between the power switches in the both bridge legs to prevent both power switches from conduction during transition periods.

The resonant circuit 1062 is electrically connected to the full-bridge switching circuit 1061 to receive the square wave voltage and convert the square wave voltage into a resonant voltage (not shown). In particular, the resonant circuit 1062 has a resonant capacitance Cr and two resonant inductances (one is a leakage inductance Lr and the other is a magnetizing inductance (not shown)) to form a LLC resonant circuit.

The transformer 1063 has an input side and an output side. The input side is electrically connected to the resonant circuit 1062 to receive the resonant voltage. In particular, the input side has at least one primary-side winding (not labeled) and the output side has at least one secondary-side winding (not labeled). As previously stated, the resonant inductances in the resonant circuit 1062 are the leakage inductance Lr of the transformer 1063 and the magnetizing inductance.

The over-voltage protection unit 1064 is electrically connected to the output side of the transformer 1063 to detect an output voltage of the power converter 106 and produce an output voltage signal Sovp, thus providing an over-voltage protection for the power converter 106. That is, the over-voltage protection unit 1064 produces the output voltage signal Sovp to protect the power converter 106 when an abnormal over-voltage output of the power converter 106 occurs. The PWM control unit 1065 produces PWM signals. Because the full-bridge switching circuit 1061 is composed of two bridge legs and each of the bridge legs has two power switches, the produced PWM signals by the PWM control unit 1065 include a first PWM signal Spwm1 and a second PWM signal Spwm2. In particular, the first PWM signal Spwm1 and the second PWM signal Spwm2 are complementary-level signals, that is, the second PWM signal Spwm2 is a low-level signal when the first PWM signal Spwm1 is a high-level signal, and vice versa. In this embodiment, the first PWM signal Spwm1 controls the first power switch Qa and the fourth power switch Qd; the second PWM signal Spwm2 controls the second power switch Qb and the third power switch Qc.

The trigging control unit 1066 receives the output voltage signal Sovp and the PWM signals Spwm1, Spwm2 and produces a trigging control signal Sen. The detailed operation description of the trigging control unit 1066 will be made as follows. The driving unit 1067 receives the trigging control signal Sen and the PWM signals Spwm1, Spwm2 to produce a plurality of gate-driving signals Sga˜Sgd for turning on or turning off the corresponding power switches Qa˜Qd. That is, the first gate-driving signal Sga is provided to control the first power switch Qa, the second gate-driving signal Sgb is provided to control the second power switch Qb, the third gate-driving signal Sgc is provided to control the third power switch Qc, and the fourth gate-driving signal Sgd is provided to control the fourth power switch Qd.

When an over-voltage output is detected by the over-voltage protection unit 1064, the over-voltage protection unit 1064 outputs the output voltage signal Sovp to control the trigging control unit 1066 so that the trigging control unit 1066 outputs the trigging control signal Sen to disable the driving unit 1067 (namely, disable driving the full-bridge switching circuit 1061) at an end of duty cycle of the corresponding PWM signal Spwm1, Spwm2. On the other hand, when a working-voltage output is detected (namely, the over-voltage output is eliminated) by the over-voltage protection unit 1064, the over-voltage protection unit 1064 outputs the output voltage signal Sovp to control the trigging control unit 1066 so that the trigging control unit 1066 outputs the trigging control signal Sen to enable the driving unit 1067 (namely, enable driving the full-bridge switching circuit 1061) at an end of duty cycle of the corresponding PWM signal Spwm1, Spwm2. The detailed description of disabling or enabling the trigging control unit 1066 by the trigging control signal Sen will be made hereinafter. In addition, the power converter 106 further has an optical coupling unit 1068. The output voltage signal Sovp is sent from the over-voltage protection unit 1064 to the trigging control unit 1066 via the optical coupling unit 1068.

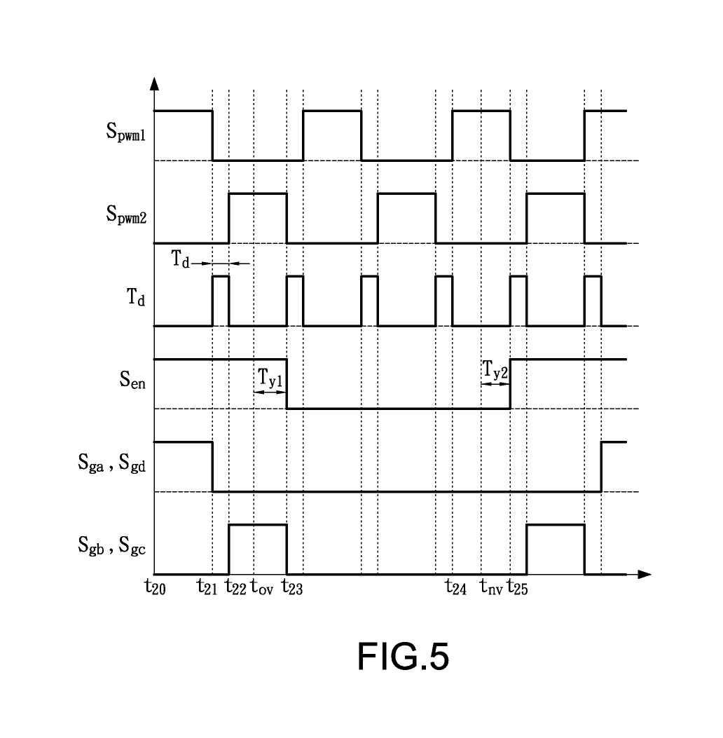

Reference is made to FIG. 5 which is a circuit diagram of the trigging control unit according to the present invention. In this embodiment, the trigging control unit 1066 includes a leading-edge triggered D-type flip-flop 10662 and a NOR gate 10664. The leading-edge triggered D-type flip-flop 10662 has a data input terminal D, a clock input terminal CLK, and at least one output terminal Q. The NOR gate 10664 has two input terminals (not labeled) and an output terminal (not labeled). The output terminal Q is connected to the clock input terminal CLK. In particular, the data input terminal D receives the output voltage signal Sovp produced from the over-voltage protection unit 1064. The two input terminals of the NOR gate 10664 receive the PWM signals Spwm1, Spwm2, respectively.

Especially, the leading-edge triggered D-type flip-flop 10662 outputs the low-level trigging control signal Sen to disable the driving unit 1067 when the over-voltage output of the power converter 106 is detected and the first PWM signal Spwm1 and the second PWM signal Spwm2 are both low-level. That is, when the over-voltage protection unit 1064 detects that the over-voltage output occurs, the over-voltage protection unit 1064 produces the output voltage signal Sovp to control the trigging control unit 1066 so that the trigging control unit 1066 outputs the low-level trigging control signal Sen to disable the driving unit 1067 at an end of duty cycle of the corresponding PWM signal Spwm1, Spwm2.

Besides, the leading-edge triggered D-type flip-flop 10662 outputs the high-level trigging control signal Sen to enable the driving unit 1067 when the working-voltage output of the power converter 106 is detected and the first PWM signal Spwm1 and the second PWM signal Spwm2 are both low-level. That is, when the over-voltage protection unit 1064 detects that the over-voltage output is eliminated and the working-voltage output is operated, the over-voltage protection unit 1064 produces the output voltage signal Sovp to control the trigging control unit 1066 so that the trigging control unit 1066 outputs the high-level trigging control signal Sen to enable the driving unit 1067 at an end of duty cycle of the corresponding PWM signal Spwm1, Spwm2. The detailed control operation will be made hereinafter with a timing diagram.

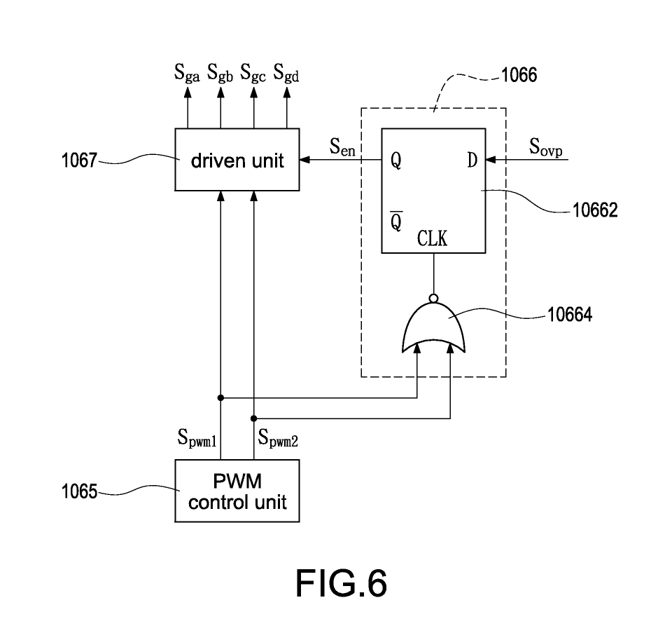

Reference is made to FIG. 6 which is a timing diagram of controlling a PWM control unit, a trigging control unit, and a driving unit according to the present invention. The graph of FIG. 6 shows, starting from the top, the first PWM signal Spwm1, the second PWM signal Spwm2, the dead time Td, the trigging control signal Sen, the gate-driving signals Sga, Sgd, and the gate-driving signals Sgb, Sgc.

As previously stated, the first PWM signal Spwm1 and the second PWM signal Spwm2 are complementary-level signals. The first PWM signal Spwm1 is turned-on during a time interval t20˜t21, in the meanwhile, the second PWM signal Spwm2 is turned-off. In addition, the second PWM signal Spwm2 is turned-on during a time interval t22˜t23, in the meanwhile, the first PWM signal Spwm1 is turned-off. Note that, the first PWM signal Spwm1 and the second PWM signal Spwm2 are periodic complementary-level signals. In addition, a time interval t21˜t22 is the dead time Td.

Furthermore, it is assumed that the power converter 106 occurs the over-voltage output at a time tov. Hence, the over-voltage protection unit 1064 produces the low-level output voltage signal Sovp when the over-voltage output of the power converter 106 is detected by the over-voltage protection unit 1064. That is, the second PWM signal Spwm2 is a high-level turned-on status (relatively, the first PWM signal Spwm1 is a low-level turned-off status) when the over-voltage output occurs between the time t22 and a time t23. At this time, the two input terminals of the NOR gate 10664 receive one logic “0” input and one logic “1” input, respectively, thus the output terminal of the NOR gate 10664 produces one logic “0” output. Also, the logic “0” output is provided to the clock input terminal CLK of the leading-edge triggered D-type flip-flop 10662. In addition, it is assumed that the initial output of the leading-edge triggered D-type flip-flop 10662 is one logic “1” output. Accordingly, the output of the leading-edge triggered D-type flip-flop 10662 is still at the high-level output when the clock input terminal CLK receives the logic “0” signal, thus continuously enabling operation of the driving unit 1067.

Until the time t23, the second PWM signal Spwm2 is converted from the high-level turned-on status into the low-level turned-off status, and meanwhile the first PWM signal Spwm1 is still at the low-level turned off status. That is, the first PWM signal Spwm1 and the second PWM signal Spwm2 are both low-level at the time t23, also the dead time occurs. At this time, the two input terminals of the NOR gate 10664 receive two logic “0” inputs, respectively, thus the output terminal of the NOR gate 10664 produces one logic “1” output. Also, the logic “1” output is provided to the clock input terminal CLK of the leading-edge triggered D-type flip-flop 10662. Accordingly, the output of the leading-edge triggered D-type flip-flop 10662 is at the low-level output (namely, the low-level trigging control signal Sen) when the clock input terminal CLK receives the logic “1” signal, thus disabling operation of the driving unit 1067.

On the other hand, it is assumed that the over-voltage output of the power converter 106 is eliminated at a time tnv, that is, when the working-voltage output is detected by the over-voltage protection unit 1064, the over-voltage protection unit 1064 outputs the high-level output voltage signal Sovp. When the working-voltage output is detected during a time interval t24˜t25, the first PWM signal Spwm1 is a high-level turned-on status (relatively, the second PWM signal Spwm2 is a low-level turned-off status). At this time, the two input terminals of the NOR gate 10664 receive one logic “1” input and one logic “0” input, respectively, thus the output terminal of the NOR gate 10664 produces one logic “0” output. Also, the logic “0” output is provided to the clock input terminal CLK of the leading-edge triggered D-type flip-flop 10662. Accordingly, the output of the leading-edge triggered D-type flip-flop 10662 is still at the low-level output when the clock input terminal CLK receives the logic “0” signal, thus continuously disabling operation of the driving unit 1067.

Until the time t25, the first PWM signal Spwm1 is converted from the high-level turned-on status into the low-level turned-off status, and meanwhile the second PWM signal Spwm2 is still at the low-level turned off status. That is, the first PWM signal Spwm1 and the second PWM signal Spwm2 are both low-level at the time t25, also the dead time occurs. At this time, the two input terminals of the NOR gate 10664 receive two logic “0” inputs, respectively, thus the output terminal of the NOR gate 10664 produces one logic “1” output. Also, the logic “1” output is provided to the clock input terminal CLK of the leading-edge triggered D-type flip-flop 10662. Accordingly, the output of the leading-edge triggered D-type flip-flop 10662 is at the high-level output (namely, the high-level trigging control signal Sen) when the clock input terminal CLK receives the logic “1” signal, thus disabling operation of the driving unit 1067.

In brief, the trigging control unit 1066 outputs the high-level trigging control signal Sen to enable the driving unit 1067 driving the full-bridge switching circuit 1061 when the over-voltage output of the power converter 106 occurs at the time tov. After the delay time Ty1 (Ty1=t23−tov), the trigging control unit 1066 outputs the low-level trigging control signal Sen at an end of duty cycle of the corresponding PWM signal Spwm1, Spwm2, namely, the dead time occurs, thus disabling the driving unit 1067 to stop driving the full-bridge switching circuit 1061. On the other hand, the trigging control unit 1066 outputs the low-level trigging control signal Sen to disable the driving unit 1067 stopping driving the full-bridge switching circuit 1061 when the working-voltage output of the power converter 106 occurs at the time tnv. After the delay time Ty2 (Ty2=t25−tnv), the trigging control unit 1066 outputs the high-level trigging control signal Sen at an end of duty cycle of the corresponding PWM signal Spwm1, Spwm2, namely, the dead time occurs, thus enabling the driving unit 1067 driving the full-bridge switching circuit 1061.

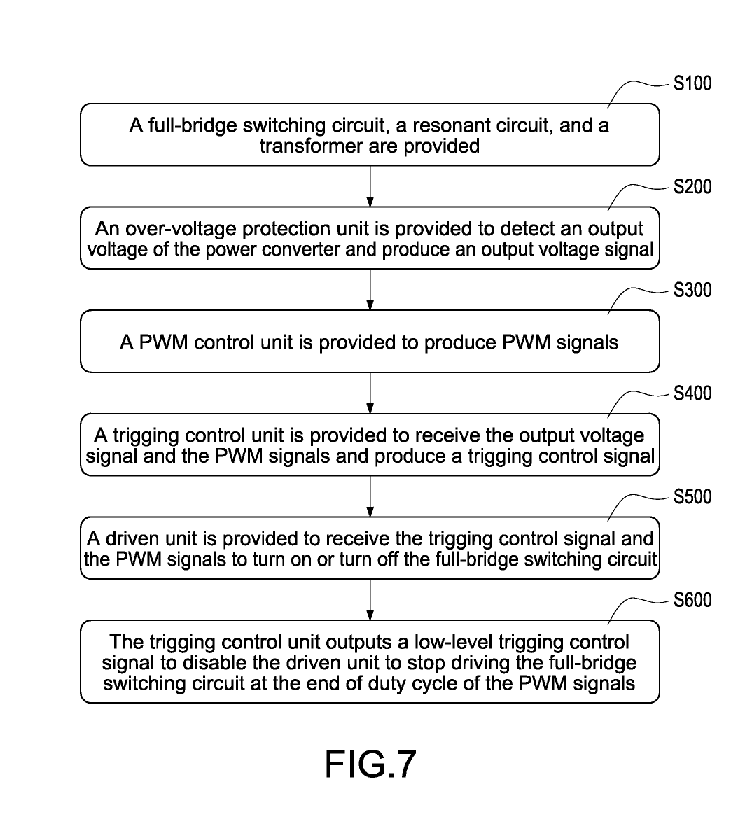

Reference is made to FIG. 7 which is a flowchart of a method of controlling a power converter according to the present invention. The method includes the following steps: A full-bridge switching circuit, a resonant circuit, and a transformer are provided (S100). The full-bridge switching circuit, which has two bridge legs composed of four power switches, is provided to convert a DC input voltage into a square wave voltage. The resonant circuit is electrically connected to the full-bridge switching circuit to receive the square wave voltage and convert the square wave voltage into a resonant voltage. The transformer has an input side and an output side. The input side is electrically connected to the resonant circuit to receive the resonant voltage. Afterward, an over-voltage protection unit is provided to detect an output voltage of the power converter and produce an output voltage signal (S200). In particular, the over-voltage protection unit is electrically connected to the output side of the transformer. Afterward, a PWM control unit is provided to produce PWM signals (S300). Afterward, a trigging control unit is provided to receive the output voltage signal and the PWM signals and produce a trigging control signal (S400). In particular, the trigging control unit includes a leading-edge triggered D-type flip-flop and a NOR gate. The leading-edge triggered D-type flip-flop has a data input terminal, a clock input terminal, and at least one output terminal. The NOR gate has two input terminals and an output terminal. The output terminal is connected to the clock input terminal. In particular, the data input terminal receives the output voltage signal produced from the over-voltage protection unit. The two input terminals of the NOR gate receive the PWM signals, respectively.

A driving unit is provided to receive the trigging control signal and the PWM signals to turn on or turn off the full-bridge switching circuit (S500). Afterward, the trigging control unit is controlled by the output voltage signal produced from the over-voltage protection unit so that the trigging control unit outputs a low-level trigging control signal to disable the driving unit to stop driving the full-bridge switching circuit at the end of duty cycle of the PWM signals (S600). In particular, the output voltage signal is an over voltage signal. In addition, the output voltage signal can be sent from the over-voltage protection unit to the trigging control unit via an optical coupling unit. When the over-voltage output of the power converter is detected and the PWM signals Spwm1, Spwm2 are both low-level, the leading-edge triggered D-type flip-flop outputs the low-level trigging control signal to disable the driving unit to stop driving the full-bridge switching circuit. In addition, a dead time is provided between the power switches in the both bridge legs to prevent both power switches from conduction during transition periods. Hence, the leading-edge triggered D-type flip-flop outputs the low-level trigging control signal to disable the driving unit to stop driving the full-bridge switching circuit when the over-voltage output is detected and the dead time occurs.

On the other hand, when a working-voltage output is detected (namely, the over-voltage output is eliminated) by the over-voltage protection unit, the over-voltage protection unit outputs the output voltage signal to control the trigging control unit so that the trigging control unit outputs the trigging control signal to enable the driving unit driving the full-bridge switching circuit at an end of duty cycle of the corresponding PWM signal. The leading-edge triggered D-type flip-flop outputs the high-level trigging control signal to enable the driving unit driving the full-bridge switching circuit when the working-voltage output of the power converter is detected and the corresponding PWM signals are both low-level. That is, when the over-voltage protection unit detects that the working-voltage output occurs, the leading-edge triggered D-type flip-flop outputs the high-level trigging control signal to enable the driving unit driving the full-bridge switching circuit at an end of duty cycle of the corresponding PWM signal.

Although several embodiments of the present invention have been described in detail, it will be understood that the disclosure is not limited to such details. Various substitutions will occur to those of ordinary skill in the art of the foregoing description. Therefore, all such substitutions and modifications are intended to be embraced within the scope of this disclosure.

What is claimed is:

1. A power converter comprising:
a full-bridge switching circuit configured for converting a DC input voltage into a square wave voltage;
a resonant circuit electrically connected to the full-bridge switching circuit to receive the square wave voltage and configured to convert the square wave voltage into a resonant voltage;
a transformer having an input side and an output side; the input side electrically connected to the resonant circuit to receive the resonant voltage;
an over-voltage protection unit electrically connected to the output side to detect an output voltage outputted from the output side and configured to produce an output voltage signal;
a PWM control unit configured for producing PWM signals;
a trigging control unit receiving the output voltage signal and the PWM signals and configured for producing a trigging control signal; and
a driving unit receiving the trigging control signal and the PWM signals and configured to turn on or turn off the full-bridge switching circuit according to the trigging control signal and the PWM signals;
wherein the trigging control unit outputs a low-level trigging control signal to disable the driving unit at an end of duty cycle of a corresponding PWM signal when an over-voltage output is detected by the over-voltage protection unit.

2. The power converter in claim 1, wherein the trigging control unit outputs a high-level trigging control signal to enable the driving unit at an end of duty cycle of the corresponding PWM signal when a working-voltage output is detected by the over-voltage protection unit.

3. The power converter in claim 2, wherein the trigging control unit comprises:
a leading-edge triggered D-type flip-flop having a data input terminal, a clock input terminal, and at least one output terminal; and
a NOR gate having two input terminals and an output terminal; the output terminal connected to the clock input terminal;
wherein the data input terminal receives the output voltage signal; the two input terminals of the NOR gate receive the PWM signals, respectively.

4. The power converter in claim 3, wherein the leading-edge triggered D-type flip-flop outputs the low-level trigging control signal to disable the driving unit when the over-voltage output is detected and the PWM signals are both low-level.

5. The power converter in claim 3, wherein the leading-edge triggered D-type flip-flop outputs the high-level trigging control signal to enable the driving unit when the working-voltage output is detected and the PWM signals are both low-level.

6. The power converter in claim 1, wherein the output voltage signal is sent from the over-voltage protection unit to the trigging control unit via an optical coupling unit.

7. The power converter in claim 3, wherein the full-bridge switching circuit has two bridge legs composed of four power switches; a dead time is provided between the power switches in the both bridge legs; the leading-edge triggered D-type flip-flop outputs the low-level trigging control signal to disable the driving unit when the over-voltage output is detected and the dead time occurs.

8. The power converter in claim 3, wherein the full-bridge switching circuit has two bridge legs composed of four power switches; a dead time is provided between the power switches in the both bridge legs; the leading-edge triggered D-type flip-flop outputs the high-level trigging control signal to enable the driving unit when the working-voltage output is detected and the dead time occurs.

9. A method of controlling a power converter; steps of the method comprising:
(a) providing a full-bridge switching circuit, a resonant circuit, and a transformer;
(b) providing an over-voltage protection unit to detect an output voltage of the power converter and produce an output voltage signal;
(c) providing a PWM control unit to produce PWM signals;
(d) providing a trigging control unit to receive the output voltage signal and the PWM signals and produce a trigging control signal;
(e) providing a driving unit to receive the trigging control signal and the PWM signals to turn on or turn off the full-bridge switching circuit; and
(f) outputting a low-level trigging control signal by the trigging control unit to disable the driving unit at an end of duty cycle of the corresponding PWM signal when an over-voltage output is detected by the over-voltage protection unit.

10. The method of controlling the power converter in claim 9, wherein after the step (f) further comprises:
(f) outputting a high-level trigging control signal by the trigging control unit to enable the driving unit at an end of duty cycle of the corresponding PWM signal when a working-voltage output is detected by the over-voltage protection unit.

11. The method of controlling the power converter in claim 10, wherein the trigging control unit comprises:
a leading-edge triggered D-type flip-flop having a data input terminal, a clock input terminal, and at least one output terminal; and
a NOR gate having two input terminals and an output terminal; the output terminal connected to the clock input terminal;
wherein the data input terminal receives the output voltage signal; the two input terminals of the NOR gate receive the PWM signals, respectively.

12. The method of controlling the power converter in claim 11, wherein the leading-edge triggered D-type flip-flop outputs the low-level trigging control signal to disable the driving unit when the over-voltage output is detected and the PWM signals are both low-level.

13. The method of controlling the power converter in claim 11, wherein the leading-edge triggered D-type flip-flop outputs the high-level trigging control signal to enable the driving unit when the working-voltage output is detected and the PWM signals are both low-level.

14. The method of controlling the power converter in claim 9, wherein the output voltage signal is sent from the over-voltage protection unit to the trigging control unit via an optical coupling unit.

15. The method of controlling the power converter in claim 11, wherein the full-bridge switching circuit has two bridge legs composed of four power switches; a dead time is provided between the power switches in the both bridge legs; the leading-edge triggered D-type flip-flop outputs the low-level trigging control signal to disable the driving unit when the over-voltage output is detected and the dead time occurs.

16. The method of controlling the power converter in claim 11, wherein the full-bridge switching circuit has two bridge legs composed of four power switches; a dead time is provided between the power switches in the both bridge legs; the leading-edge triggered D-type flip-flop outputs the high-level trigging control signal to enable the driving unit when the working-voltage output is detected and the dead time occurs.
